(19) United States
(12) Patent Application Publication
(10) Pub. No.: US 2022/0278813 A1
(43) Pub. Date: Sep. 1, 2022

(54) CONFIGURING GUARD INTERVALS FOR MULTIPLE UPLINK CARRIERS

(71) Applicant: QUALCOMM Incorporated, San Diego, CA (US)

(72) Inventors: Bo CHEN, Beijing (CN); Chenxi HAO, Beijing (CN); Wentao ZHANG, Beijing (CN); Hao XU, Beijing (CN)

(21) Appl. No.: 17/597,896

(22) PCT Filed: Aug. 3, 2020
(86) PCT No.: PCT/CN2020/106528

§ 371 Date: Jan. 28, 2022

(30) Foreign Application Priority Data
Aug. 29, 2019 (CN) PCT/CN2019/103181

(51) Int. Cl. H04L 5/00; H04W 72/04; H04L 5/14; H04L 27/26

(52) U.S. Cl. CPC H04L 5/0094; H04W 72/0453; H04W 72/0446; H04W 72/042; H04L 5/1469; H04L 27/2607

(57) ABSTRACT

Various aspects of the present disclosure generally relate to wireless communication. In some aspects, a user equipment (UE) may receive a configuration that identifies a carrier that is to include a guard interval when transitioning between a first carrier and a second carrier for uplink transmissions. The UE may transmit the uplink transmissions according to the configuration. Numerous other aspects are provided.

### CROSS-REFERENCE TO RELATED APPLICATION

This patent application claims priority to International Patent Application No. PCT/CN2019/103181, filed on Aug. 29, 2019, entitled “CONFIGURING GUARD INTERVALS FOR MULTIPLE UPLINK CARRIERS,” and assigned to the assignee hereof. The disclosure of the prior application is considered part of and is incorporated by reference into this patent application.

### FIELD OF THE DISCLOSURE

Aspects of the present disclosure generally relate to wireless communication and to techniques and apparatuses for configuring guard intervals for multiple uplink carriers.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, and/or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless communication network may include a number of base stations (BSs) that can support communication for a number of user equipment (UEs). A user equipment (UE) may communicate with a base station (BS) via the downlink and uplink. The downlink (or forward link) refers to the communication link from the BS to the UE, and the uplink (or reverse link) refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, and/or the like.

The above multiple access technologies have been adopted in various telecommunication standards to provide a common protocol that enables different user equipment to communicate on a municipal, national, regional, and even global level. New Radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. However, as the demand for mobile broadband access continues to increase, there exists a need for further improvements in LTE and NR technologies. Preferably, these improvements should be applicable to other multiple access technologies and the telecommunication standards that employ these technologies.

### SUMMARY

In some aspects, a method of wireless communication, performed by a UE, may include receiving a configuration that identifies a carrier that is to include a guard interval when transitioning between a first carrier and a second carrier for uplink transmissions; and transmitting the uplink transmissions according to the configuration.

In some aspects, a method of wireless communication, performed by a base station, may include determining a carrier that is to include a guard interval when a UE is transitioning between a first carrier and a second carrier for uplink transmissions; and transmitting a configuration that identifies the carrier that is to include the guard interval to the UE.

In some aspects, a UE for wireless communication may include memory and one or more processors operatively coupled to the memory. The memory and the one or more processors may be configured to receive a configuration that identifies a carrier that is to include a guard interval when transitioning between a first carrier and a second carrier for uplink transmissions; and transmit the uplink transmissions according to the configuration.

In some aspects, a base station for wireless communication may include memory and one or more processors operatively coupled to the memory. The memory and the one or more processors may be configured to determine a carrier that is to include a guard interval when a UE is transitioning between a first carrier and a second carrier for uplink transmissions; and transmit a configuration that identifies the carrier that is to include the guard interval to the UE.

In some aspects, a non-transitory computer-readable medium may store one or more instructions for wireless communication. The one or more instructions, when executed by one or more processors of a UE, may cause the one or more processors to: receive a configuration that identifies a carrier that is to include a guard interval when transitioning between a first carrier and a second carrier for uplink transmissions; and transmit the uplink transmissions according to the configuration.

In some aspects, a non-transitory computer-readable medium may store one or more instructions for wireless communication. The one or more instructions, when executed by one or more processors of a base station, may cause the one or more processors to: determine a carrier that is to include a guard interval when a UE is transitioning between a first carrier and a second carrier for uplink transmissions; and transmit a configuration that identifies the carrier that is to include the guard interval to the UE.

In some aspects, an apparatus for wireless communication may include means for receiving a configuration that identifies a carrier that is to include a guard interval when transitioning between a first carrier and a second carrier for uplink transmissions; and means for transmitting the uplink transmissions according to the configuration.

In some aspects, an apparatus for wireless communication may include means for determining a carrier that is to include a guard interval when a UE is transitioning between a first carrier and a second carrier for uplink transmissions; and means for transmitting a configuration that identifies the carrier that is to include the guard interval to the UE.

Aspects generally include a method, apparatus, system, computer program product, non-transitory computer-readable medium, user equipment, base station, wireless communication device, and/or processing system as substantially described herein with reference to and as illustrated by the accompanying drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a block diagram conceptually illustrating an example of a wireless communication network, in accordance with various aspects of the present disclosure.

FIG. 2 is a block diagram conceptually illustrating an example of a base station in communication with a UE in a wireless communication network, in accordance with various aspects of the present disclosure.

FIG. 3 is a block diagram conceptually illustrating an example of a frame structure in a wireless communication network, in accordance with various aspects of the present disclosure.

FIGS. 4 and 5 are diagrams illustrating examples of configuring guard intervals for multiple uplink carriers, in accordance with various aspects of the present disclosure.

FIG. 6 is a diagram illustrating an example process performed, for example, by a UE, in accordance with various aspects of the present disclosure.

FIG. 7 is a diagram illustrating an example process performed, for example, by a base station, in accordance with various aspects of the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with 3G and/or 4G wireless technologies, aspects of the present disclosure can be applied in other generation-based communication systems, such as 5G and later, including NR technologies.

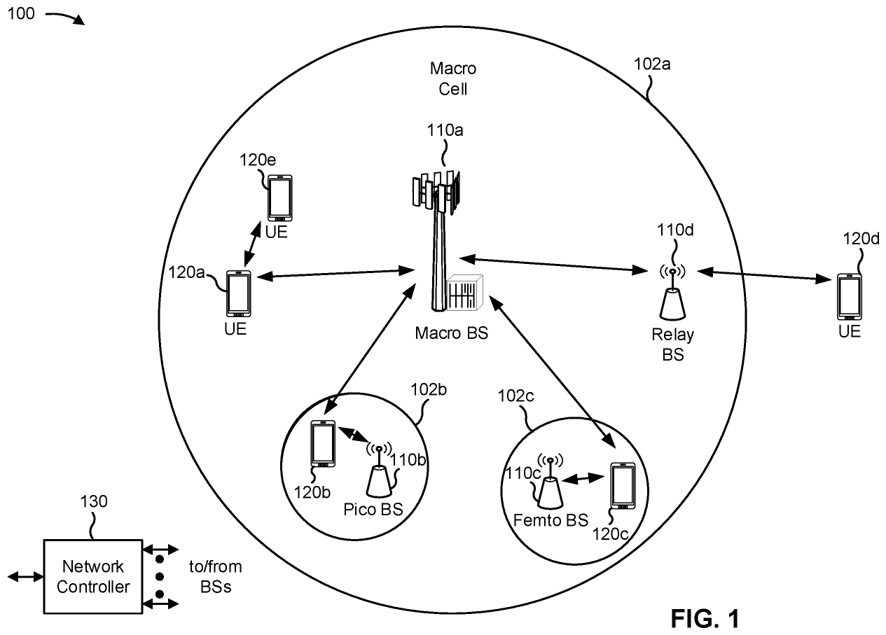

FIG. 1 is a diagram illustrating a wireless network 100 in which aspects of the present disclosure may be practiced. The wireless network 100 may be an LTE network or some other wireless network, such as a 5G or NR network. The wireless network 100 may include a number of BSs 110 (shown as BS 110a, BS 110b, BS 110c, and BS 110d) and other network entities. A BS is an entity that communicates with user equipment (UEs) and may also be referred to as a base station, a NR BS, a Node B, a gNB, a 5G node B (NB), an access point, a transmit receive point (TRP), and/or the like. Each BS may provide communication coverage for a particular geographic area. In 3GPP, the term “cell” can refer to a coverage area of a BS and/or a BS subsystem serving this coverage area, depending on the context in which the term is used.

ABS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). ABS for a macro cell may be referred to as a macro BS. A BS for a pico cell may be referred to as a pico BS. ABS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. ABS may support one or multiple (e.g., three) cells. The terms “eNB”, “base station”, “NR BS”, “gNB”, “TRP”, “AP”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces such as a direct physical connection, a virtual network, and/or the like using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay station 110d may communicate with macro BS 110a and a UE 120d in order to facilitate communication between BS 110a and UE 120d. A relay station may also be referred to as a relay BS, a relay base station, a relay, and/or the like.

Wireless network 100 may be a heterogeneous network that includes BSs of different types, e.g., macro BSs, pico BSs, femto BSs, relay BSs, and/or the like. These different types of BSs may have different transmit power levels, different coverage areas, and different impacts on interference in wireless network 100. For example, macro BSs may have a high transmit power level (e.g., 5 to 40 watts) whereas pico BSs, femto BSs, and relay BSs may have lower transmit power levels (e.g., 0.1 to 2 watts).

A network controller 130 may couple to a set of BSs and may provide coordination and control for these BSs. Network controller 130 may communicate with the BSs via a backhaul. The BSs may also communicate with one another, e.g., directly or indirectly via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, and/or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, location tags, and/or the like, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a Customer Premises Equipment (CPE). UE 120 may be included inside a housing that houses components of UE 120, such as processor components, memory components, and/or the like.

In general, any number of wireless networks may be deployed in a given geographic area. Each wireless network may support a particular RAT and may operate on one or more frequencies. A RAT may also be referred to as a radio technology, an air interface, and/or the like. A frequency may also be referred to as a carrier, a frequency channel, and/or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, and/or the like), a mesh network, and/or the like. In this case, the UE 120 may perform scheduling operations, resource selection operations, and/or other operations described elsewhere herein as being performed by the base station 110.

As indicated above, FIG. 1 is provided as an example. Other examples may differ from what is described with regard to FIG. 1.

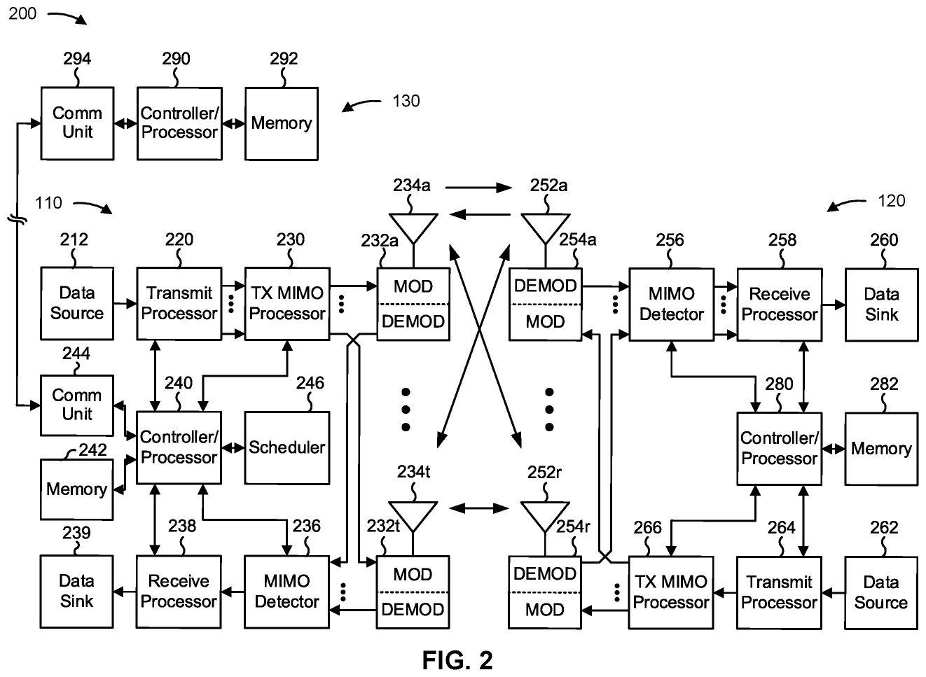

FIG. 2 shows a block diagram of a design 200 of base station 110 and UE 120, which may be one of the base stations and one of the UEs in FIG. 1. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, and/or the like) and provide overhead symbols and control symbols. Transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM and/or the like) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively. According to various aspects described in more detail below, the synchronization signals can be generated with location encoding to convey additional information.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like. In some aspects, one or more components of UE 120 may be included in a housing.

On the uplink, at UE 120, a transmit processor 264 may receive and process data from a data source 262 and control information (e.g., for reports comprising RSRP, RSSI, RSRQ, CQI, and/or the like) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM, CP-OFDM, and/or the like), and transmitted to base station 110. At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Network controller 130 may include communication unit 294, controller/processor 290, and memory 292.

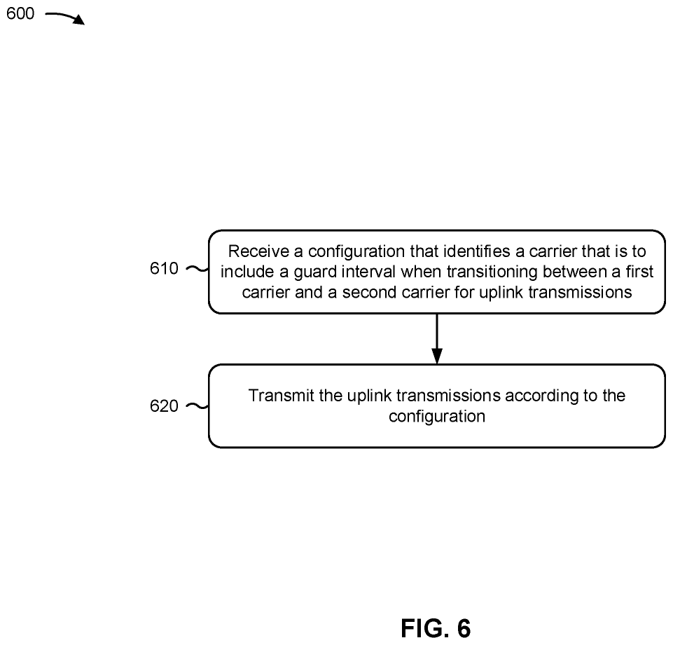

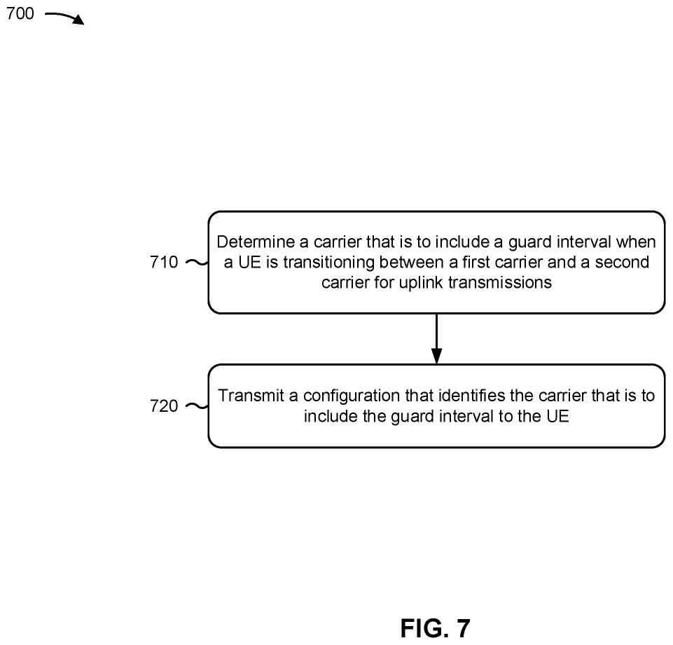

Controller/processor 240 of base station 110, controller/processor 280 of UE 120, and/or any other component(s) of FIG. 2 may perform one or more techniques associated with configuring guard intervals for multiple uplink carriers, as described in more detail elsewhere herein. For example, controller/processor 240 of base station 110, controller/processor 280 of UE 120, and/or any other component(s) of FIG. 2 may perform or direct operations of, for example, process 600 of FIG. 6, process 700 of FIG. 7, and/or other processes as described herein. Memories 242 and 282 may store data and program codes for base station 110 and UE 120, respectively. In some aspects, memory 242 and/or memory 282 may comprise a non-transitory computer-readable medium storing one or more instructions for wireless communication. For example, the one or more instructions, when executed by one or more processors of the base station 110 and/or the UE 120, may perform or direct operations of, for example, process 600 of FIG. 6, process 700 of FIG. 7, and/or other processes as described herein. A scheduler 246 may schedule UEs for data transmission on the downlink and/or uplink.

In some aspects, UE 120 may include means for receiving a configuration that identifies a carrier that is to include a guard interval when transitioning between a first carrier and a second carrier for uplink transmissions, means for transmitting the uplink transmissions according to the configuration, and/or the like. In some aspects, such means may include one or more components of UE 120 described in connection with FIG. 2, such as controller/processor 280, transmit processor 264, TX MIMO processor 266, MOD 254, antenna 252, DEMOD 254, MIMO detector 256, receive processor 258, and/or the like.

In some aspects, base station 110 may include means for determining a carrier that is to included a guard interval when a UE is transitioning between a first carrier and a second carrier for uplink transmissions, means for transmitting a configuration that identifies the carrier that is to include the guard interval to the UE, and/or the like. In some aspects, such means may include one or more components of base station 110 described in connection with FIG. 2, such as antenna 234, DEMOD 232, MIMO detector 236, receive processor 238, controller/processor 240, transmit processor 220, TX MIMO processor 230, MOD 232, antenna 234, and/or the like.

As indicated above, FIG. 2 is provided as an example. Other examples may differ from what is described with regard to FIG. 2.

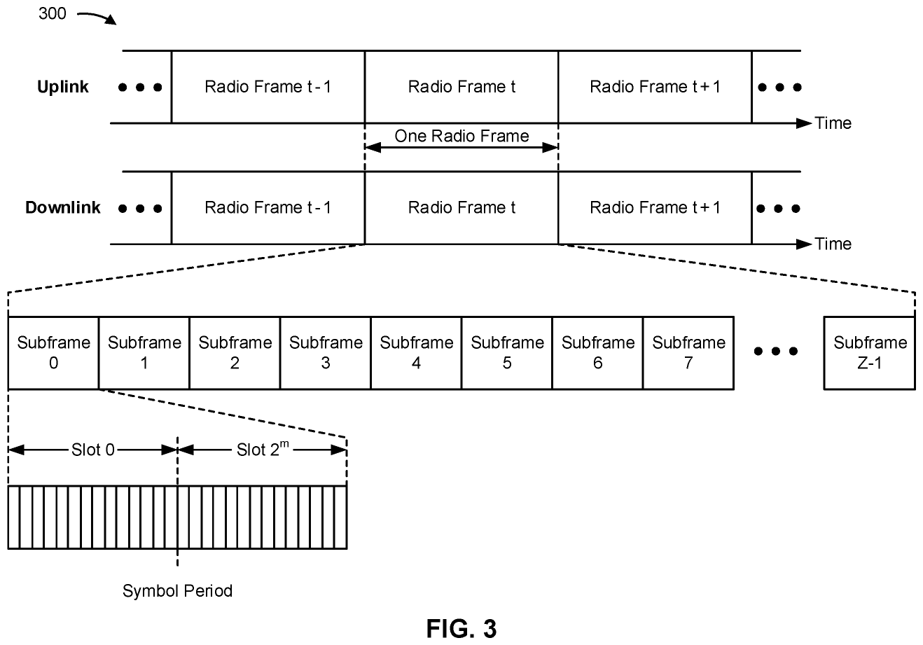

FIG. 3 shows an example frame structure 300 for frequency division duplexing (FDD) in a telecommunications system (e.g., NR). The transmission timeline for each of the downlink and uplink may be partitioned into units of radio frames (sometimes referred to as frames). Each radio frame may have a predetermined duration (e.g., 10 milliseconds (ms)) and may be partitioned into a set of Z (Z≥1) subframes (e.g., with indices of 0 through Z−1). Each subframe may have a predetermined duration (e.g., 1 ms) and may include a set of slots (e.g., 2^{m} slots per subframe are shown in FIG. 3, where m is a numerology used for a transmission, such as 0, 1, 2, 3, 4, and/or the like). Each slot may include a set of L symbol periods. For example, each slot may include fourteen symbol periods (e.g., as shown in FIG. 3), seven symbol periods, or another number of symbol periods. In a case where the subframe includes two slots (e.g., when m=1), the subframe may include 2L symbol periods, where the 2L symbol periods in each subframe may be assigned indices of 0 through 2L−1. In some aspects, a scheduling unit for the FDD may be frame-based, subframe-based, slot-based, symbol-based, and/or the like.

While some techniques are described herein in connection with frames, subframes, slots, and/or the like, these techniques may equally apply to other types of wireless communication structures, which may be referred to using terms other than “frame,” “subframe,” “slot,” and/or the like in 5G NR. In some aspects, a wireless communication structure may refer to a periodic time-bounded communication unit defined by a wireless communication standard and/or protocol. Additionally, or alternatively, different configurations of wireless communication structures than those shown in FIG. 3 may be used.

In certain telecommunications (e.g., NR), a base station may transmit synchronization signals. For example, a base station may transmit a primary synchronization signal (PSS), a secondary synchronization signal (SSS), and/or the like, on the downlink for each cell supported by the base station. The PSS and SSS may be used by UEs for cell search and acquisition. For example, the PSS may be used by UEs to determine symbol timing, and the SSS may be used by UEs to determine a physical cell identifier, associated with the base station, and frame timing. The base station may also transmit a physical broadcast channel (PBCH). The PBCH may carry some system information, such as system information that supports initial access by UEs.

As indicated above, FIG. 3 is provided as an example. Other examples may differ from what is described with regard to FIG. 3.

In carrier aggregation, a UE 120 and a base station 110 may communicate via multiple carriers. The carriers may have different frequencies. These features can enable an increased bandwidth and throughput for communications between the UE 120 and the base station 110. In some carrier aggregation configurations, cross-carrier scheduling may be used. Generally, cross-carrier scheduling involves transmissions across carriers. For example, with cross-carrier scheduling, the UE 120 may transmit uplink transmissions on a carrier configured for time division duplexing (TDD) and a carrier configured for FDD. In some cases, uplink transmissions on the TDD carrier and the FDD carrier may occur concurrently. However, such concurrent uplink transmissions may utilize additional transmitters, thereby increasing a hardware complexity of the UE 120.

Accordingly, in some carrier aggregation scenarios, uplink transmissions on the TDD carrier and the FDD carrier also may occur non-concurrently (e.g., in a time division multiplexing (TDM) scenario). Similarly, the UE 120 may be configured for dual connectivity communication or supplemental uplink communication, in which uplink transmissions on the TDD carrier and the FDD carrier may occur non-concurrently. In such cases, the UE 120 may switch between transmitting on the TDD carrier and the FDD carrier. Such switching may be associated with a particular latency that may result in collision or failure of the uplink transmissions.

Some techniques and apparatuses described herein provide for a pattern of guard intervals (i.e., switching periods) for uplink transmissions between carriers. In this way, collisions between scheduled uplink transmissions on different carriers may be reduced or eliminated, thereby improving uplink communication involving multiple carriers.

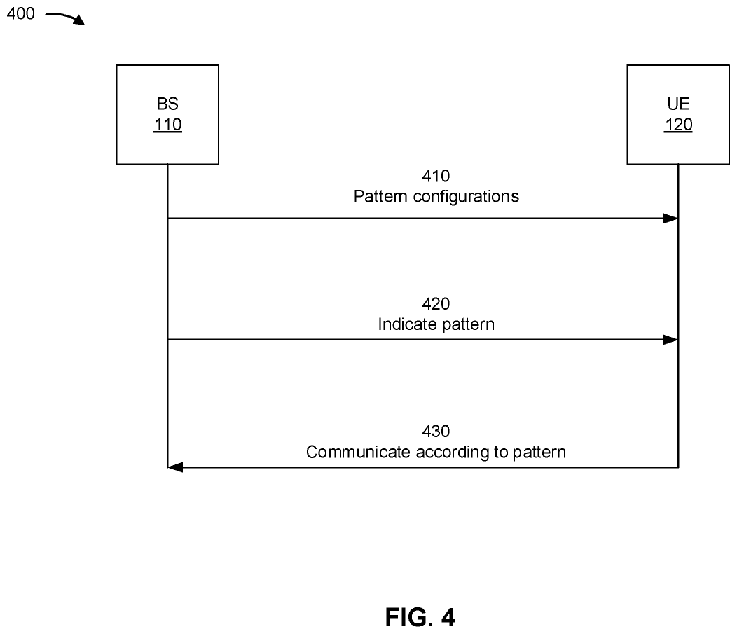

FIG. 4 is a diagram illustrating an example 400 of configuring guard intervals for multiple uplink carriers, in accordance with various aspects of the present disclosure. As shown in FIG. 4, a BS 110 may communicate a pattern for uplink transmissions to a UE 120, and the UE 120 may communicate with the BS 110 according to the pattern. In some aspects, the UE 120 may transmit uplink transmissions to the BS 110 in accordance with carrier aggregation communication, dual connectivity communication, or supplemental uplink communication. In carrier aggregation, dual connectivity, or supplemental uplink, the UE 120 may transmit uplink transmissions on a first carrier (e.g., a first component carrier), such as a TDD carrier (e.g., a carrier in a frequency band configured for TDD), and on a second carrier (e.g., a second component carrier), such as an FDD uplink carrier (e.g., an uplink carrier in a frequency band configured for FDD). In carrier aggregation, the FDD uplink carrier may be associated with an FDD downlink carrier (e.g., a downlink carrier in a frequency band configured for FDD). In some aspects, the TDD carrier may have a wider bandwidth and the FDD carrier may have a narrower bandwidth.

As shown in FIG. 4, and by reference number 410, the BS 110 may transmit, and the UE 120 may receive, a configuration for a pattern of guard intervals (i.e., switching periods). The BS 110 may transmit the configuration via radio resource control (RRC) signaling. The configuration may identify a quantity of guard intervals per period (e.g., per subframe, per slot, and/or the like). For each guard interval, the configuration may identify a set of parameters that define a location of the guard interval. For example, the set of parameters may identify a duration (e.g., a quantity of symbols) of the guard interval, a starting time location (e.g., an index of a starting symbol) of the guard interval, a carrier identifier that identifies the carrier that includes the guard interval, a slot identifier that identifies the slot that includes the guard interval, and/or the like. In some aspects, the configuration may be particular to the UE 120 (e.g., particular to a capability of the UE 120). A guard interval may refer to a time interval during which the UE 120 is not to transmit or receive communications.

The BS 110 may determine one or more sets of parameters (e.g., a set of parameters for each guard interval identified) based at least in part on a frame structure of the first carrier and/or the second carrier. In particular, the BS 110 may determine the one or more sets of parameters based at least in part on a configuration for uplink transmissions and/or a configuration for uplink slots (e.g., uplink transmission opportunity locations) on the first carrier and/or the second carrier. In some aspects, the BS 110 may determine the one or more sets of parameters based at least in part on a configuration or a scheduling for an uplink transmission (e.g., a physical uplink shared channel (PUSCH) transmission, a physical uplink control channel (PUCCH) transmission, a sounding reference signal (SRS) transmission, and/or the like) on the first carrier or the second carrier.

In some aspects, the BS 110 may determine a configuration or a scheduling for uplink transmissions, a configuration for uplink slots, and/or the like. For example, the BS 110 may determine a configuration for uplink slots on the first carrier and the second carrier such that uplink slots on the first carrier and uplink slots on the second carrier are orthogonal in time (e.g., uplink slots on the first carrier do not time overlap with uplink slots on the second carrier). In some cases, the BS 110 may determine a configuration for uplink slots that results in overlapping uplink slots on the first carrier and the second carrier. In such cases, the BS 110 may determine whether an uplink transmission (e.g., a PUSCH transmission, a PUCCH transmission, an SRS transmission, and/or the like) is to be scheduled in the first carrier or the second carrier. In some aspects, the configuration for the pattern of guard intervals may also identify, or may be associated with, a configuration or a scheduling for uplink transmissions, a configuration for uplink slots, and/or the like.

In some aspects, the BS 110 may transmit, and the UE 120 may receive, a set of configurations for a pattern of guard intervals (e.g., a configuration in the set may identify a particular pattern of guard intervals), such as via RRC signaling. The set of configurations may be associated with a set identifier, and each configuration in the set may be associated with a respective pattern identifier. In some aspects, the set of configurations may be particular to a bandwidth part of a carrier. In some aspects, the set of configurations may identify a particular configuration (e.g., a particular pattern) as a default configuration (e.g., a default pattern).

As shown by reference number 420, the BS 110 may transmit, and the UE 120 may receive, an indication of a pattern of guard intervals (i.e., switching periods) that the UE 120 is to use when transitioning between a first carrier and a second carrier for uplink transmissions. For example, the indication may identify (e.g., by a pattern identifier) a particular pattern of a set of patterns configured for the UE 120. The BS 110 may transmit the indication of the pattern via RRC signaling (e.g., RRC reconfiguration signaling), via a medium access control-control element (MAC-CE), downlink control information (DCI), and/or the like.

In some aspects, the indication of the pattern may identify a pattern that is to be activated. In such a case, activation of the pattern by the UE 120 may cause deactivation of a previously-active pattern (e.g., the default pattern). In some aspects, the indication of the pattern may identify a pattern (e.g., a currently-active pattern) that is to be deactivated. In such a case, deactivation of the pattern by the UE 120 may cause activation of a previously-active pattern (e.g., the default pattern).

As shown by reference number 430, the UE 120 may communicate with the BS 110 according to the activated configuration for a pattern of guard intervals. In other words, the UE 120 may transmit, and the BS 110 may receive, uplink transmissions on the first carrier and the second carrier according to the activated configuration. In this way, the activated configuration may indicate a location of guard intervals (i.e., switching periods) that are to be used when the UE 120 is transitioning (e.g., switching) between the first carrier and the second carrier for the uplink transmissions, thereby improving success of the uplink transmissions. In some aspects, the UE 120 may be transitioning between the first carrier and the second carrier when the UE 120 has transmitted one or more uplink transmissions on the first carrier and is scheduled to transmit one or more uplink transmissions on the second carrier (e.g., without any further intervening transmissions on the first carrier), or when the UE 120 has transmitted one or more uplink transmissions on the second carrier and is scheduled to transmit one or more uplink transmissions on the first carrier (e.g., without any further intervening transmissions on the second carrier).

As indicated above, FIG. 4 is provided as an example. Other examples may differ from what is described with respect to FIG. 4.

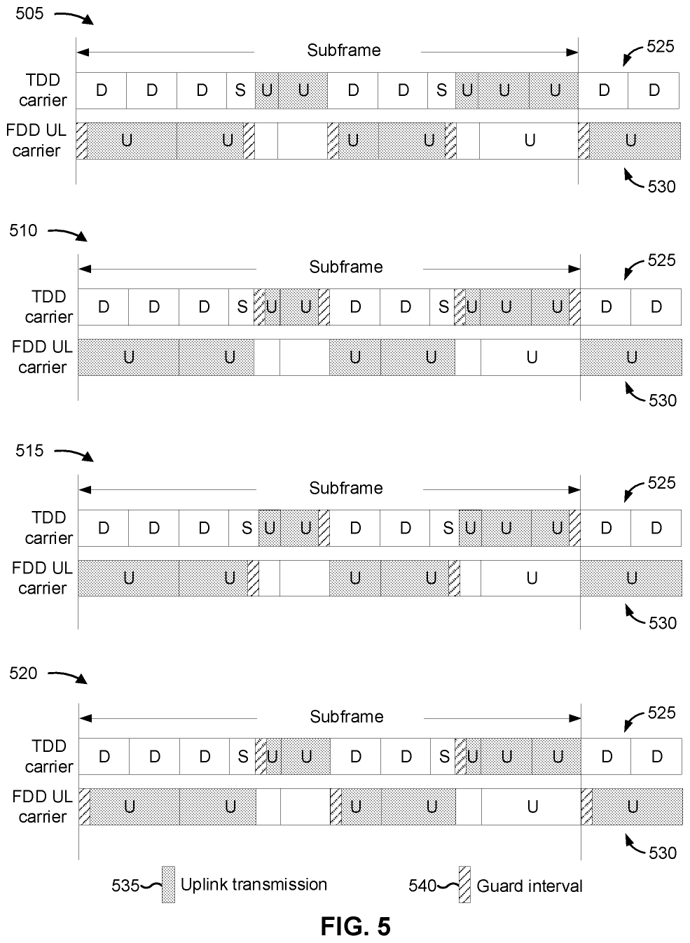

FIG. 5 is a diagram illustrating examples 505, 510, 515, and 520 of configuring guard intervals for multiple uplink carriers, in accordance with various aspects of the present disclosure. In particular, FIG. 5 shows example patterns for guard intervals. As shown by examples 505, 510, 515, and 520, a UE (e.g., UE 120) and a BS (e.g., BS 110) may communicate on a first carrier 525 and a second carrier 530. The first carrier 525 may be a TDD carrier and the second carrier 530 may be an FDD uplink carrier, as described in more detail above in connection with FIG. 4. In some aspects, the first carrier 525 and the second carrier 530 both may be TDD carriers.

Examples 505, 510, 515, and 520 may represent carrier aggregation communication, dual connectivity communication, or supplemental uplink communication. In carrier aggregation communication, examples 505, 510, 515, and 520 may additionally include an FDD downlink carrier, as described in more detail above in connection with FIG. 4. In some aspects, examples 505, 510, 515, and 520 may represent TDM communication, in which uplink transmissions 535 on the first carrier 525 and the second carrier 530 are non-concurrent. For example, the UE may forgo (e.g., according to a configuration or scheduling indicated by the BS) one or more uplink transmission opportunities (or a portion thereof) on the first carrier 525 when transmitting uplink transmissions 535 on the second carrier 530 and/or may forgo (e.g., according to a configuration or scheduling indicated by the BS) one or more uplink transmission opportunities (or a portion thereof) on the second carrier 530 when transmitting uplink transmissions 535 on the first carrier 525.

In some aspects, the first carrier 525 (e.g., the TDD carrier) may have a particular subframe structure defined by a sequence of uplink transmission opportunities (U) and downlink transmission opportunities (D). For example, as shown in FIG. 5, the first carrier 525 (e.g., the TDD carrier) may have a subframe structure defined by a sequence of three downlink transmission opportunity (D) slots, a special transmission opportunity (S) slot, which may be used for a downlink transmission or an uplink transmission, one uplink transmission opportunity (U) slot, two downlink transmission opportunity (D) slots, a special transmission opportunity (S) slot, and two uplink transmission opportunity (U) slots.

As shown by example 505, a pattern for guard intervals 540 may indicate that guard intervals 540 are to be located in the second carrier 530 (e.g., the FDD uplink carrier) at transitions in uplink transmissions 535 from the second carrier 530 to the first carrier 525 and at transitions in uplink transmissions 535 from the first carrier 525 to the second carrier 530. In particular, the pattern may indicate a first guard interval 540 for the second carrier 530 at a transition in uplink transmissions 535 from the second carrier 530 to the first carrier 525 and a second guard interval 540 for the second carrier 530 at a transition in uplink transmissions 535 from the first carrier 525 to the second carrier 530. Accordingly, the first guard interval 540 may have a time location in the second carrier 530 between an uplink transmission 535 on the second carrier 530 and an uplink transmission 535 on the first carrier 525, and the second guard interval 540 may have a time location in the second carrier 530 between an uplink transmission 535 on the first carrier 525 and an uplink transmission 535 on the second carrier 530.

As shown by example 510, a pattern for guard intervals 540 may indicate that guard intervals 540 are to be located in the first carrier 525 (e.g., the TDD carrier) at transitions in uplink transmissions 535 from the second carrier 530 to the first carrier 525 and at transitions in uplink transmissions 535 from the first carrier 525 to the second carrier 530. In particular, the pattern may indicate a first guard interval 540 for the first carrier 525 at a transition in uplink transmissions 535 from the second carrier 530 to the first carrier 525 and a second guard interval 540 for the first carrier 525 at a transition in uplink transmissions 535 from the first carrier 525 to the second carrier 530. Accordingly, the first guard interval 540 may have a time location in the first carrier 525 between an uplink transmission 535 on the second carrier 530 and an uplink transmission 535 on the first carrier 525, and the second guard interval 540 may have a time location in the first carrier 525 between an uplink transmission 535 on the first carrier 525 and an uplink transmission 535 on the second carrier 530.

As shown by example 515, a pattern for guard intervals 540 may indicate that guard intervals 540 are to be located in the second carrier 530 (e.g., the FDD uplink carrier) at transitions in uplink transmissions 535 from the second carrier 530 to the first carrier 525, and that guard intervals 540 are to be located in the first carrier 525 (e.g., the TDD carrier) at transitions in uplink transmissions 535 from the first carrier 525 to the second carrier 530. In particular, the pattern may indicate a first guard interval 540 for the second carrier 530 at a transition in uplink transmissions 535 from the second carrier 530 to the first carrier 525 and a second guard interval 540 for the first carrier 525 at a transition in uplink transmissions 535 from the first carrier 525 to the second carrier 530. Accordingly, the first guard interval 540 may have a time location in the second carrier 530 between an uplink transmission 535 on the second carrier 530 and an uplink transmission 535 on the first carrier 525, and the second guard interval 540 may have a time location in the first carrier 525 between an uplink transmission 535 on the first carrier 525 and an uplink transmission 535 on the second carrier 530.

As shown by example 520, a pattern for guard intervals 540 may indicate that guard intervals 540 are to be located in the first carrier 525 (e.g., the TDD carrier) at transitions in uplink transmissions 535 from the second carrier 530 to the first carrier 525, and that guard intervals 540 are to be located in the second carrier 530 (e.g., the FDD uplink carrier) at transitions in uplink transmissions 535 from the first carrier 525 to the second carrier 530. In particular, the pattern may indicate a first guard interval 540 for the first carrier 525 at a transition in uplink transmissions 535 from the second carrier 530 to the first carrier 525 and a second guard interval 540 for the second carrier 530 at a transition in uplink transmissions 535 from the first carrier 525 to the second carrier 530. Accordingly, the first guard interval 540 may have a time location in the first carrier 525 between an uplink transmission 535 on the second carrier 530 and an uplink transmission 535 on the first carrier 525, and the second guard interval 540 may have a time location in the second carrier 530 between an uplink transmission 535 on the first carrier 525 and an uplink transmission 535 on the second carrier 530.

As indicated above, FIG. 5 is provided as an example. Other examples may differ from what is described with respect to FIG. 5.

FIG. 6 is a diagram illustrating an example process 600 performed, for example, by a UE, in accordance with various aspects of the present disclosure. Example process 600 is an example where a UE (e.g., UE 120 and/or the like) performs operations associated with configuring guard intervals for multiple uplink carriers.

As shown in FIG. 6, in some aspects, process 600 may include receiving a configuration that identifies a carrier that is to include a guard interval when transitioning between a first carrier and a second carrier for uplink transmissions (block 610). For example, the UE (e.g., using antenna 252, DEMOD 254, MIMO detector 256, receive processor 258, controller/processor 280, and/or the like) may receive a configuration that identifies a carrier that is to include a guard interval when transitioning between a first carrier and a second carrier for uplink transmissions, as described above.

As further shown in FIG. 6, in some aspects, process 600 may include transmitting the uplink transmissions according to the configuration (block 620). For example, the UE (e.g., using controller/processor 240, transmit processor 220, TX MIMO processor 230, MOD 232, antenna 234, and/or the like) may transmit the uplink transmissions according to the configuration, as described above.

Process 600 may include additional aspects, such as any single aspect or any combination of aspects described below and/or in connection with one or more other processes described elsewhere herein.

In a first aspect, the first carrier is in a frequency band configured for TDD and the second carrier is in a frequency band configured for FDD or TDD. In a second aspect, alone or in combination with the first aspect, the first carrier and the second carrier are associated with carrier aggregation communication, dual connectivity communication, or supplemental uplink communication.

In a third aspect, alone or in combination with one or more of the first and second aspects, the configuration indicates the guard interval for the second carrier at a transition in uplink transmissions from the second carrier to the first carrier. In a fourth aspect, alone or in combination with one or more of the first through third aspects, the configuration indicates the guard interval for the first carrier at a transition in uplink transmissions from the second carrier to the first carrier.

In a fifth aspect, alone or in combination with one or more of the first through fourth aspects, the configuration indicates the guard interval for the first carrier at a transition in uplink transmissions from the first carrier to the second carrier. In a sixth aspect, alone or in combination with one or more of the first through fifth aspects, the configuration indicates the guard interval for the second carrier at a transition in uplink transmissions from the first carrier to the second carrier.

In a seventh aspect, alone or in combination with one or more of the first through sixth aspects, the configuration is based at least in part on at least one of uplink transmission configurations or uplink slot configurations of the first carrier and the second carrier. In an eighth aspect, alone or in combination with one or more of the first through seventh aspects, the configuration is received via radio resource control signaling.

In a ninth aspect, alone or in combination with one or more of the first through eighth aspects, process 600 further includes receiving (e.g., using antenna 252, DEMOD 254, MIMO detector 256, receive processor 258, controller/processor 280, and/or the like) an indication to activate or deactivate the configuration via radio resource control signaling, a medium access control-control element, or downlink control information. In a tenth aspect, alone or in combination with one or more of the first through ninth aspects, activation of the configuration causes deactivation of another configuration. In an eleventh aspect, alone or in combination with one or more of the first through tenth aspects, deactivation of the configuration causes activation of another configuration.

In a twelfth aspect, alone or in combination with one or more of the first through eleventh aspects, the configuration indicates at least one of a quantity of guard intervals per period, a duration of the guard interval, a starting time location of the guard interval, or a slot that is to include the guard interval.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, by a BS, in accordance with various aspects of the present disclosure. Example process 700 is an example where a BS (e.g., BS 110 and/or the like) performs operations associated with configuring guard intervals for multiple uplink carriers.

As shown in FIG. 7, in some aspects, process 700 may include determining a carrier that is to include a guard interval when a UE is transitioning between a first carrier and a second carrier for uplink transmissions (block 710). For example, the BS (e.g., using controller/processor 240 and/or the like) may determine a carrier that is to include a guard interval when a UE is transitioning between a first carrier and a second carrier for uplink transmissions, as described above.

As further shown in FIG. 7, in some aspects, process 700 may include transmitting a configuration that identifies the carrier that is to include the guard interval to the UE (block 720). For example, the BS (e.g., using controller/processor 240, transmit processor 220, TX MIMO processor 230, MOD 232, antenna 234, and/or the like) may transmit a configuration that identifies the carrier that is to include the guard interval to the UE, as described above.

Process 700 may include additional aspects, such as any single aspect or any combination of aspects described below and/or in connection with one or more other processes described elsewhere herein.

In a first aspect, the first carrier is in a frequency band configured for TDD and the second carrier is in a frequency band configured for FDD or TDD. In a second aspect, alone or in combination with the first aspect, the first carrier and the second carrier are associated with carrier aggregation communication, dual connectivity communication, or supplemental uplink communication.

In a third aspect, alone or in combination with one or more of the first and second aspects, the configuration indicates the guard interval for the second carrier at a transition in uplink transmissions from the second carrier to the first carrier. In a fourth aspect, alone or in combination with one or more of the first through third aspects, the configuration indicates the guard interval for the first carrier at a transition in uplink transmissions from the second carrier to the first carrier.

In a fifth aspect, alone or in combination with one or more of the first through fourth aspects, the configuration indicates the guard interval for the first carrier at a transition in uplink transmissions from the first carrier to the second carrier. In a sixth aspect, alone or in combination with one or more of the first through fifth aspects, the configuration indicates the guard interval for the second carrier at a transition in uplink transmissions from the first carrier to the second carrier.

In a seventh aspect, alone or in combination with one or more of the first through sixth aspects, the configuration is based at least in part on at least one of uplink transmission configurations or uplink slot configurations of the first carrier and the second carrier. In an eighth aspect, alone or in combination with one or more of the first through seventh aspects, the configuration is transmitted via radio resource control signaling.

In a ninth aspect, alone or in combination with one or more of the first through eighth aspects, process 700 further includes transmitting (e.g., using controller/processor 240, transmit processor 220, TX MIMO processor 230, MOD 232, antenna 234, and/or the like) an indication to activate or deactivate the configuration via radio resource control signaling, a medium access control-control element, or downlink control information. In a tenth aspect, alone or in combination with one or more of the first through ninth aspects, activation of the configuration causes deactivation of another configuration. In an eleventh aspect, alone or in combination with one or more of the first through tenth aspects, deactivation of the configuration causes activation of another configuration.

In a twelfth aspect, alone or in combination with one or more of the first through eleventh aspects, the configuration indicates at least one of a quantity of guard intervals per period, a duration of the guard interval, a starting time location of the guard interval, or a slot that is to include the guard interval.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

The foregoing disclosure provides illustration and description, but is not intended to be exhaustive or to limit the aspects to the precise form disclosed. Modifications and variations may be made in light of the above disclosure or may be acquired from practice of the aspects.

As used herein, the term “component” is intended to be broadly construed as hardware, firmware, and/or a combination of hardware and software. As used herein, a processor is implemented in hardware, firmware, and/or a combination of hardware and software.

As used herein, satisfying a threshold may, depending on the context, refer to a value being greater than the threshold, greater than or equal to the threshold, less than the threshold, less than or equal to the threshold, equal to the threshold, not equal to the threshold, and/or the like.

It will be apparent that systems and/or methods described herein may be implemented in different forms of hardware, firmware, and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items, and may be used interchangeably with “one or more.” Furthermore, as used herein, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” and/or the like are intended to be open-ended terms. Further, the phrase “based on” is intended to mean “based, at least in part, on” unless explicitly stated otherwise.

What is claimed is:

1. A method of wireless communication performed by a user equipment (UE), comprising:
receiving a configuration that identifies a carrier that is to include a guard interval when transitioning between a first carrier and a second carrier for uplink transmissions; and
transmitting the uplink transmissions according to the configuration.

2. The method of claim 1, wherein the first carrier is in a frequency band configured for time division duplexing (TDD) and the second carrier is in a frequency band configured for frequency division duplexing (FDD) or TDD.

3. The method of claim 1, wherein the first carrier and the second carrier are associated with carrier aggregation communication, dual connectivity communication, or supplemental uplink communication.

4. The method of claim 1, wherein the configuration indicates the guard interval for the second carrier at a transition in uplink transmissions from the second carrier to the first carrier.

5. The method of claim 1, wherein the configuration indicates the guard interval for the first carrier at a transition in uplink transmissions from the second carrier to the first carrier.

6. The method of claim 1, wherein the configuration indicates the guard interval for the first carrier at a transition in uplink transmissions from the first carrier to the second carrier.

7. The method of claim 1, wherein the configuration indicates the guard interval for the second carrier at a transition in uplink transmissions from the first carrier to the second carrier.

8. The method of claim 1, wherein the configuration is based at least in part on at least one of uplink transmission configurations or uplink slot configurations of the first carrier and the second carrier.

9. The method of claim 1, wherein the configuration is received via radio resource control signaling.

10. The method of claim 1, further comprising receiving an indication to activate or deactivate the configuration via radio resource control signaling, a medium access control-control element, or downlink control information.

11. The method of claim 10, wherein activation of the configuration causes deactivation of another configuration.

12. The method of claim 10, wherein deactivation of the configuration causes activation of another configuration.

13. The method of claim 1, wherein the configuration indicates at least one of a quantity of guard intervals per period, a duration of the guard interval, a starting time location of the guard interval, or a slot that is to include the guard interval.

14. A method of wireless communication performed by a base station, comprising:
determining a carrier that is to include a guard interval when a user equipment (UE) is transitioning between a first carrier and a second carrier for uplink transmissions; and
transmitting a configuration that identifies the carrier that is to include the guard interval to the UE.

15. The method of claim 14, wherein the first carrier is in a frequency band configured for time division duplexing (TDD) and the second carrier is in a frequency band configured for frequency division duplexing (FDD) or TDD.

16. The method of claim 14, wherein the first carrier and the second carrier are associated with carrier aggregation communication, dual connectivity communication, or supplemental uplink communication.

17. The method of claim 14, wherein the configuration indicates the guard interval for the second carrier at a transition in uplink transmissions from the second carrier to the first carrier.

18. The method of claim 14, wherein the configuration indicates the guard interval for the first carrier at a transition in uplink transmissions from the second carrier to the first carrier.

19. The method of claim 14, wherein the configuration indicates the guard interval for the first carrier at a transition in uplink transmissions from the first carrier to the second carrier.

20. The method of claim 14, wherein the configuration indicates the guard interval for the second carrier at a transition in uplink transmissions from the first carrier to the second carrier.

21. The method of claim 14, wherein the configuration is based at least in part on at least one of uplink transmission configurations or uplink slot configurations of the first carrier and the second carrier.

22. The method of claim 14, wherein the configuration is transmitted via radio resource control signaling.

23. The method of claim 14, further comprising transmitting an indication to activate or deactivate the configuration via radio resource control signaling, a medium access control-control element, or downlink control information.

24. The method of claim 23, wherein activation of the configuration causes deactivation of another configuration.

25. The method of claim 23, wherein deactivation of the configuration causes activation of another configuration.

26. The method of claim 14, wherein the configuration indicates at least one of a quantity of guard intervals per period, a duration of the guard interval, a starting time location of the guard interval, or a slot that is to include the guard interval.

27. A user equipment (UE) for wireless communication, comprising:
a memory; and
one or more processors operatively coupled to the memory, the memory and the one or more processors configured to:
receive a configuration that identifies a carrier that is to include a guard interval when transitioning between a first carrier and a second carrier for uplink transmissions; and
transmit the uplink transmissions according to the configuration.

28. The UE of claim 27, wherein the first carrier and the second carrier are associated with carrier aggregation communication, dual connectivity communication, or supplemental uplink communication.

29. A base station for wireless communication, comprising:
a memory; and
one or more processors operatively coupled to the memory, the memory and the one or more processors configured to:
determine a carrier that is to include a guard interval when a user equipment (UE) is transitioning between a first carrier and a second carrier for uplink transmissions; and
transmit a configuration that identifies the carrier that is to include the guard interval to the UE.

30. The base station of claim 29, wherein the first carrier and the second carrier are associated with carrier aggregation communication, dual connectivity communication, or supplemental uplink communication.
